(19) United States
(12) Patent Application Publication
(10) Pub. No.: US 2004/0213350 A1
(43) Pub. Date: Oct. 28, 2004

(54) Interface format for PCM and DSD devices

(76) Inventors: Peter J. Frith, Edinburgh (GB); Wei-Hung Huang, Hsing-Chu (TW)

Correspondence Address: DICKSTEIN SHAPIRO MORIN & OSHINSKY LLP, 2101 L STREET NW, WASHINGTON, DC, 20037-1526, US

(21) Appl. No.: 10/421,808

(22) Filed: Apr. 24, 2003

(51) Int. Cl. H04B 14/04

(52) U.S. Cl. 375/242

(57) ABSTRACT

The present invention relates to a signal interface format for communicating or transferring PCM and DSD digital audio signals particularly, although not exclusively, between chips within digital audio equipment such as CD and DVD players and recorders. The present invention provides a method of and apparatus for interfacing between components of a system or between systems, which accommodates both PCM and DSD digital audio signals. The interface for caring these signals comprises a number of dedicated interface channels, at least one (DATA) dedicated for data transmission where the source or audio data is in PCM or DSD format, and three channels (BITCLK, MCLK, and LRCLK) dedicated for clock signal transmission. Preferably these four channels are implemented on four conductors between two chips, each chip comprising four corresponding input/output pins. Each dedicated DATA interface channel preferably has two source data channels multiplexed onto it. In the case of PCM, all three interface clocking channels (BITCLK, MCLK, LRCLK) are required, whereas for DSD only two interface clocking channels (BITCLK, MCLK) are required. Additional data interface channels (DATA2, etc) can be added to accommodate further source or audio data channels.

### FIELD OF THE INVENTION

The present invention relates to a signal interface format for communicating or transferring PCM and DSD digital audio signals particularly, although not exclusively, between chips within digital audio equipment such as CD and DVD players and recorders.

### BACKGROUND OF THE INVENTION

The introduction of the DSD™ (Direct Stream Digital), or SACD™ (Super Audio CD) data format developed by Philips™ and Sony™, has lead to the need to develop audio DACs (digital to analog convertes) to support this new data format.

The existing mainstream audio format, used by CD and DED players, uses a PCM (Pulse Code Modulation) representation of the audio signals. The Audio signal is sampled at the Nyquist rate or greater (typically 44.1 or 48 ks/s, or higher) and data samples of 16 to 24 bit word length are stored This system has proven adequate for digital audio representation to date, but is by no means a perfect way of storing audio data

SACD™ discs store audio data in a delta-sigma-modulated over-sampled ‘bit-stream’ or DSD representation. Audio samples of only 1 bit width are stored at much higher rates, typically 64x the 44.1 ks/s rate used in CD.

An increasing number of consumer equipment types such as CD and DVD players are being designed to accommodate both types of formats. This typically either requires the use of dedicated DACs for each format type, or a single DAC chip with two input interfaces, one for PCM and one for DSD signals. A further alternative is to have a single input interface which is switched internally to different circuits within the DAC chip to accommodate both signal formats.

FIG. 2 shows examples of two of the above identified prior art DAC chip arrangements. FIG. 2a shows the internal arrangement for an audio filter DAC 4′ using a prior art input interface. The interface comprises two dedicated interfaces, one for PCM signals and one for DSD signals.

For processing PCM input signals, the DAC 4′ comprises a PCM interface function 21 which receives the multiplexed data signals and the necessary clocking signals to present the data in a format (clocked digital words) suitable for the interpolation filters 22. The interpolation filters (one for each channel) provide the input for the Sigma Delta Modulators 23 for each data channel, which in turn each output a stream of single bits depending on the data words supplied to their respective modulator 23. These bit streams are each applied to a DAC 24 which convert them to analogue signals for each channel for outputting from the audio filter DAC chip 4′.

The bit streams provided by the modulators 23 are similar to DSD data signals or bitstreams recovered by the DSD interface 25. Therefore when receiving DSD format input signals, these can be routed directly to the input of a respective DAC 24 for conversion to analogue signals. This arrangement obviously suffers from requiring two sets of interfaces which doubles the number of device pins required this increases assembly cost (more wire bonds), increases package size and material cost, increases area of both sending and receiving chips (extra bonding pads and associated ESD protection structures and input/output buffer circuitry), as well as increasing the PCB size and cost due to the extra PCE wiring real estate required. Similarly, implementing upgrades from PCM-only to PCM/DSD systems also suffers from these drawbacks.

FIG. 2b shows an alternative prior art arrangement in which common input pins are used for transferring both PCM and DSD signals to an audio filter DAC chip 4′. This requires the use of a switching matrix to map the signals assigned to each conducting path or pin depending on whether PCM or DSD signals are being transferred. The different signal types for each of PCM and DSD signal transfer are shown assigned to the conductors typically used in prior art arrangements. The PCM conducting paths arc then routed to a PCM interface 21 (as shown in FIG. 2a), and the DSD conducting paths to a DSD interface 25, the rest of the audio filter DAC arrangement being as shown in FIG. 2a.

Note that the Pin input connections shown imply not only a dedicated physical pin on the package exterior, but also the bond wire between the pin and the chip, the bonding pad on the chip and associated ESD protection structures and probably an on-chip buffer circuit.

On transfer from DSD to PCM mode and vice versa, since data lines become clock lines or vice versa, it is hard to ensure a glitchless transition, for either transmitter or receiver, with all clocks and data switching cleanly at exactly the right time, and no spurious signals being generated by the sender or misinterpreted due to (?) the internal latency of the receiving circuitry.

### SUMMARY OF THE INVENTION

In general terms in one aspect, embodiments of the present invention provide a method of and apparatus for interfacing between components of a system or between systems, which accommodates both PCM and DSD digital audio signals. The interface for carrying these signals comprises a number of dedicated interface channels, at least one (DATA) dedicated for data transmission where the source or audio data is in PCM or DSD format, and three channels (BITCLK, MCLK, and LRCLK) dedicated for clock signal transmission. Preferably these four channels are implemented on four conductors between two chips, each chip comprising four corresponding input/output pins. Each dedicated DATA interface channel preferably has two source data channels multiplexed onto it. In the case of PCM, all three interface clocking channels (BITCLK, MCLK, LRCLK) are required, whereas for DSD only two interface clocking channels (BITCLK, MCLK) are required. Additional data interface channels (DATA2, etc) can be added to accommodate further source or audio data channels.

This arrangement provides a mum number of channels or pins for receiving/transmitting both PCM and DSD signals over the same interface. It also avoids the prior art glitchiness described above which is due to switching a particular channel to carry data for one format type and then clock signals for the other. In this arrangement the channels are dedicated to either data or clock signals, and do not carry both depending on the mode of operation.

This arrangement also allows the use of the same number of interface channels for any given number of source data channels, irrespective of whether they are PCM or DSD or a combination Thus a fixed number of conductors and input/output pins can be used for a given number of source data channels, irrespective of whether PCM or DSD format data is being transferred.

In particular, in one aspect the present invention provides an apparatus for receiving PCM or DSD signals; comprising: means for receiving multiplexed PCM and DSD format data on a same dedicated interface data channel (DATA); means for receiving or transmitting a first clock signal for both PCM and DSD data reception on a first dedicated interface clock channel (BITCLK); means for receiving or transmitting a second clock signal for both PCM and DSD data reception on a second dedicated interface clock Tunnel (MCLK).

In another aspect the present invention provides an apparatus for transmitting PCM or DSD signals; comprising: means for transmitting multiplexed PCM and DSD format data on a same dedicated interface data channel (DATA); means for receiving or transmitting a first clock signal for both PCM and DSD data reception on a first dedicated interface clock channel (BITCLK); means for receiving or transmitting a second clock signal for both PCM and DSD data reception on a second dedicated interface clock channel (MCLK).

Preferably the apparatus comprise means for demultiplexing or multiplexing respectively, DSD source data channels from/to the interface data channel (DATA),

In another aspect the present invention provides a method for receiving PCM or DSD signals; comprising: receiving multiplexed PCM or DSD format data on a same dedicated interface data channel (DATA); receiving or transmitting a first clock signal for both PCM and DSD data reception on a fist dedicated interface clock channel (BITCLK); receiving or transmitting a second clock signal for both PCM and DSD data reception on a second dedicated interface clock channel (MCLK).

In another aspect the present invention provides a method for Fitting PCM or DSD signals; comprising: transmitting multiplexed PCM or DSD format data on a same dedicated interface data channel (DATA); receiving or transmitting a first clock signal for both PCM and DSD data reception on a first dedicated interface clock channel (BITCLK); receiving or transmitting a second clock signal for both PCM and DSD data reception on a second dedicated interface clock channel RICH).

In another aspect the present invention provides an interface signal for transmitting or receiving DSD signals; comprising: a data interface signal (DATA) ca g multiplexed DSD format data; a first clock signal (BITCLK) having a rate equal to the bit duration of the unmultiplexed DSD format data; a second clock signal (MCLK) having a rate higher than the first clock signal.

Preferably one or more preferably two interface clock (BITCLK, MCLK) channels carry the same rate CLK signal irrespective of whether PCM or DSD format source data is being transferred. For example the bit clocking rate (BITCLK in PCM and DSDCLK64 in DSD) are the same. Preferably this rate is 64 fs, where fs is the data sampling frequency. Additionally or alternatively, the highest rate interface clock channel (MCLK) rate is the same for both PCM (used to clock the interpolation filters) and DSD (used for clocking demultiplexed and bi-phase data). Preferably this rate is 128 fs for uni-phase DSD data or 256 fs for bi-phase DSD data transmission; or higher in each case.

This reduces the need for internal switching within both the sending and receiving chips, so that only the DATA channel requires switching when the signal format is changed from PCM to DSD format data, and vice versa. This also allows a mix of DSD and PCM channels to be transmitted simultaneously on respective channels without extra channels.

If the third clock signal is used, its rate is dependent on the sample rate of any PCM data carried on the DATA channel. It is used to frame the PCM data words, and to distinguish between say left and right channels if these are multiplexed onto one data wire.

This arrangement will typically be implemented in data processing chips which need to transfer that data to other chips, for example from decoder chips to audio DACs for DVD) and CD players, or from audio ADCs to encoder chips in DVD or CD recorder equipment. Equipment designers and manufacturers in these fields will usually already have a well-established implementations of the PCM data path. Since the PCM data is still in the same format as is commonly already used, only the DSD data paths need any substantial new circuitry to upgrade these field-proven existing circuits.

The additional circuitry for the sending chip preferably comprises means for generating a strobe pulse from the first clock signal (BITCLK) which is aligned to an appropriate edge of MCLK to sample the data interface channel (DATA) in order to recover the multiplexed DSD source data channel signals. In addition, there is preferably also an alignment circuit for time aligning said recovered DSD source data channel signals.

The clock signals for the three interface clock channels (BITCLK, MCLK, LRCLK) may be generated by either the data sending or receiving chip. Alternatively these clock signals may be generated separately of either chip and merely received by both the data sending (eg DVD decoder) chip and the data receiving (eg DVD audio DAC) chip.

In another aspect the present invention provides a method of transmitting digital audio signals, comprising generating an interface data channel (DATA) capable of carrying both PCM and DSD format data, said channel carrying two multiplexed channels of PCM or DSD format data; generating a first interface clock channel (BITCLK) dedicated to carrying a clock signal having a rate dependent on the bit duration of said data; and generating a second interface clock channel (MCLK) dedicated to carrying a clock signal having a higher rate than the first clock charnel (BITCLK).

In another aspect the present invention provides a method of receiving digital audio signals, comprising: receiving a data channel (DATA) dedicated to carrying two multiplexed channels of PCM or DSD format data; receiving a first clock channel (BITCLK) dedicated to carrying a clock signal having a rate dependent on the bit duration of said data channel; and receiving a second clock channel (MCLK) dedicated to ring a clock signal having a higher rate than the first clock channel.

In another aspect the present invention provides a device for transmitting digital audio signals, comprising: means for generating an interface data channel (DATA) dedicated to carrying two multiplexed channels of PCM or DSD format data; means for generating a first interface clock channel (BITCLK) dedicated to carrying a clock signal having a rate dependent on the bit duration of said data channel (DATA); and means for generating a second clock interface channel (MCLK) dedicated to carrying a clock signal having a higher rate than the first clock channel (BITCLK).

In another aspect the present invention provides a device for receiving digital audio signals, comprising: means for receiving a data channel (DATA) dedicated to carrying two multiplexed channels of PCM or DSD format data; means for receiving a first clock channel (BITCLK) dedicated to carping a clock signal having a rate dependent on the bit duration of said data channel; and means for receiving a second clock channel (MCLK) dedicated to carrying a clock signal having a higher rate Man the first clock channel.

In another aspect the present invention provides a signal for communicating DSD and PCM digital audio signals having DSD or PCM data formats, the signal comprising: a data channel (DATA) dedicated to carrying two multiplexed channels of PCM or DSD format data; a first clock channel (BITCLK) dedicated to carrying a clock signal having a rate dependent on the bit duration of said data channel; a second clock channel (MCLK) dedicated to carrying a clock signal having a higher rate than the first clock channel; wherein said first clock channel rate is the same for both PCM and DSD format data.

In another aspect the present invention provides a method of transmitting PCM and DSD data, comprising: generating an interface data channel (DATA) for carrying two multiplexed channels of the PCM or DSD data; and generating a bit clocking channel (BITCLK) carrying a clock signal having the same rate for both PCM and DSD data, said rate being equal to the bit rate of multiplexed PCM data or half the bit rate of multiplexed DSD data.

In another aspect the present invention provides a method of transmitting DSD data comprising: generating an interface signal having four channels and which is suitable for carrying both DSD and PCM data; the signal comprising: a data channel (DATA) which carries two multiplexed DSD data channels; a first interface clock channel (BITCLK) which carries a clock signal having a rate dependent on the bit duration of said data carried by the data channel (DATA); a second interface clock channel (MCLK) which carries a clock signal having a hither rate than the first clock channel (BITCLK); and a third interface clock channel (LRCLK) which either carries no signal or carries a clock signal having a rate equal to the sampling rate of the data.

### BRIEF DESCRIPTION OF THE DRAWINGS

The present invention will now be described in detail with reference to the following drawings, by way of example only and without intending to be limiting, in which:

FIGS. 1a and 1b shows a schematic of a CD or DVD audio player and recorder respectively;

FIG. 2a shows a prior art audio filter DAC arrangement for accommodating both PCM and DSD data formats;

FIG. 2b shows a mapping switch matrix for another prior art audio filter DAC arrangement for accommodating both PCM and DSD data formats on the same input pins;

FIG. 3a is a schematic of a PCM audio filter DAC arrangement;

FIG. 3b shows the input signals for the arrangement of FIG. 3a;

FIG. 4a shows a transfer diagram for Left Justified;

FIG. 4b shows a transfer diagram for I²S mode PCM data;

FIG. 4c shows a transfer diagram for RJ mode PCM data PCM data;

FIG. 5a shows the input signals for a DSD audio filter DAC arrangement;

FIG. 5b shows the input signals for a DSD audio filter DAC arrangement using bi-phasing;

FIG. 5c shows the input signals for a DSD audio filter DAC arrangement using bi-phasing employing a quadrature DSDCLK128 clock

FIGS. 6a and 6b show a schematic of a PCM interface circuit together with a respective timing diagram;

FIG. 7a shows an audio filter DAC arrangement according to an embodiment of the present invention, for both PCM and DSD data formats;

FIG. 7b shows the input signals for the arrangement of FIG. 7a;

FIG. 8 shows a schematic of a DSD interface arrangement according to an embodiment of the present invention;

FIG. 9 shows a strobing circuit arrangement for accurate time alignment of the DSD digital datasteam;

FIG. 10 shows a Left/Right channel bit alignment circuit; and

FIG. 11 shows a circuit arrangement for the decoder of FIG. 1a to provide an interface according to an embodiment of the present invention.

### DETAILED DESCRIPTION

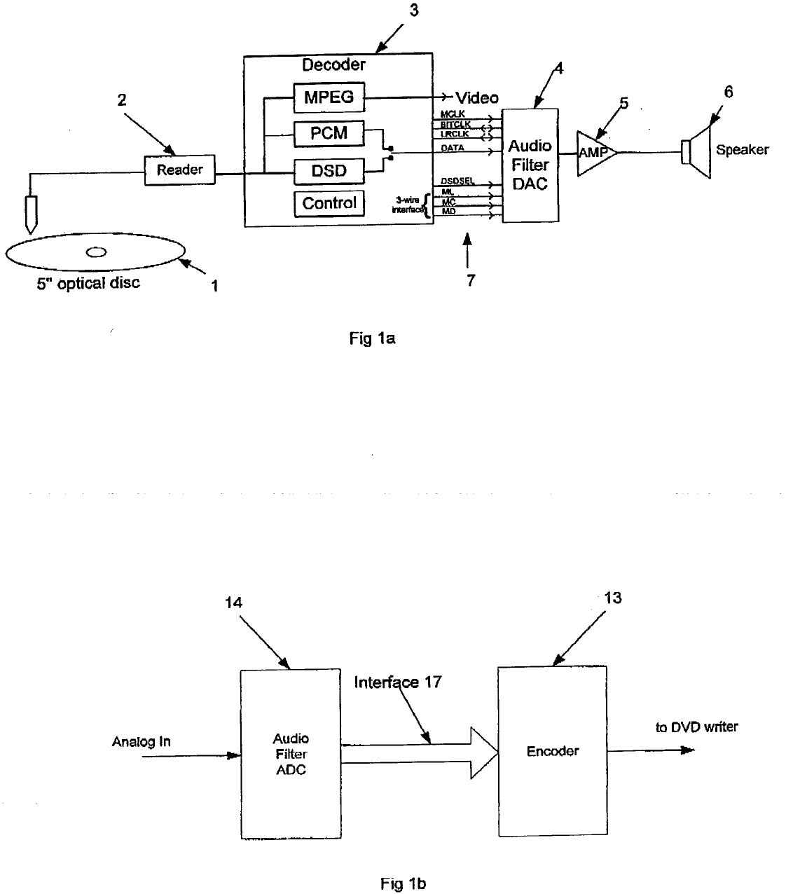

Referring to FIG. 1a, a schematic of a DVD player is shown which incorporates an embodiment of the present invention. The player comprises a reader 2 which reads a DVD disk 1i a decoder 3 which decodes the data read by the reader 2, an audio filter DAC 4 which converts the digital signals supplied to it by the decoder 3 into analogue signals which are then amplified by an amplifier 5 and output as sound by a speaker 6.

When the decoded signals from the disk 1 are in PCM or DSD format, they are transferred to the Audio filter DAC 4 over an interface 7 comprising a number of conducting paths for providing data, clock and control signals. The particular arrangement of the paths is described in more detail below.

FIG. 1b shows a schematic of part of a DVD recorder having an analogue filter ADC 14 corresponding to the audio filter DAC 4 of FIG. 1a, but performing the operation of digitising incoming analogue audio signals into DSD or PCM digital audio signals. These digital signals are then transferred to an encoder 13 corresponding to the decoder 3 of FIG. 1a but performing the operation of encoding the PCM or DSD signals for writing to a DVD disk (not shown). The interface 17 between the audio filter ADC 14 and the ender 13 corresponds to the interface 7 in FIG. 1a between the decoder 3 and the audio filter DAC 4. This interface 17 preferably comprises the same conducting path arrangement used for the interface 7 of FIG. 1a, and which is described below in more detail.

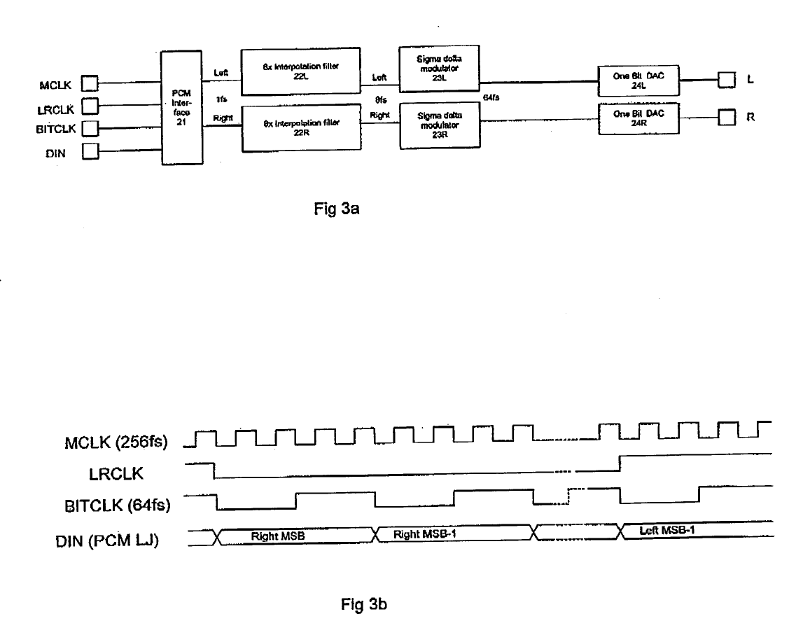

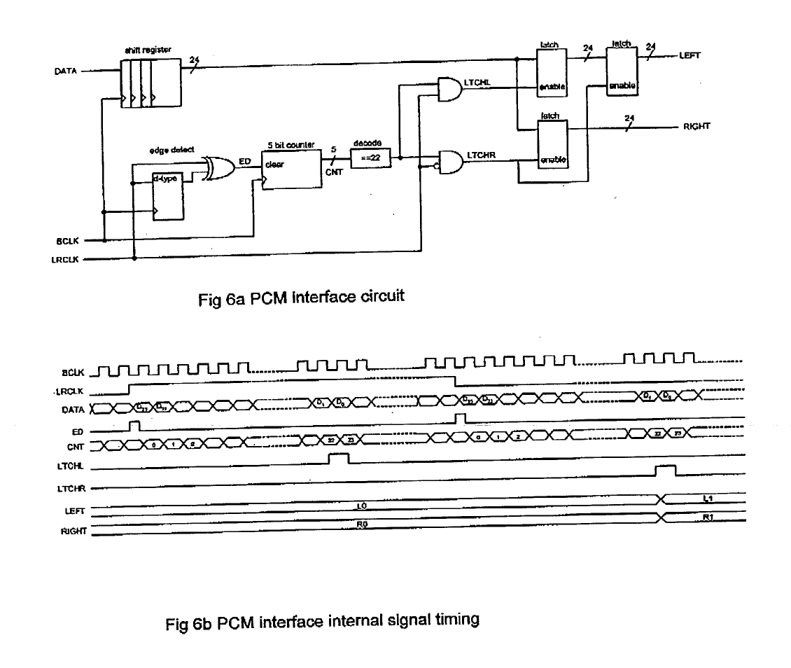

In an application such as FIG. 1a, playback of the PCM data requires sending of the 16 or 24 bit data words from the decoder 3 to the relevant part of the audio filter DAC 4 shown in FIG. 3a The words are recovered by the PCM interface 21 (details of which are shown schematically in FIG. 6), and output at the audio sample rate fs to left and right audio channel interpolation filters 22. The filters 22L and 22R generally interpolate their audio source data to a higher rate (typically 8X fs). This higher rate data is then oversampled at say 64fs and digitally sigma delta modulated by modulator 23L or 23R, to create a digital delta-sigma bit-steam, for each source channel, which is qualitatively similar to a SACD DSD data stream. The bit-streams are then applied to respective DACs 24L or 24R, and converted into analog signals (LOP or ROP).

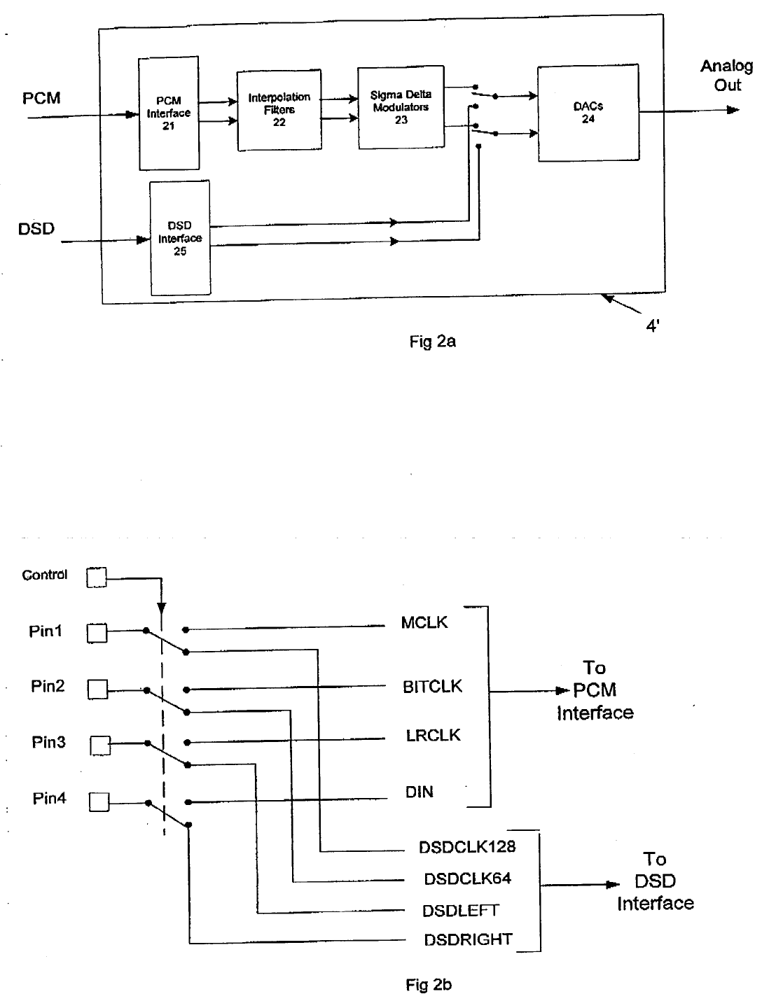

Playback of DSD data can be as simple as bypassing the digital interpolation filters 22 and sigma delta modulators 23 used in the PCM processing chain (as shown in FIG. 2a), and directly applying the already modulated DSD bit-stream to the DAC's 24.

In either case, the digital delta-sigma streams input to the DAC's 24, if regarded as perfect (fast rise-time, low edge jitter, accurate logic high and low levels) analogue waveforms, have an audio frequency spectrum substantially identical to that spectrum desired at the output, with almost all quantisation noise pushed up to higher frequencies. The DAC's 24 can thus be a one-bit DAC, typically implemented as a switched capacitor DAC, usually including some low-pass filtering to prevent ultrasonic energy impairing the performance of subsequent audio frequency amplifiers or transducers

FIG. 3b illustrates a clock and data scheme commonly used to transfer PCM data. In order to perform the digital interpolation of the PCM data at the fs sample rate (of the audio data) up to typically 64x or 128x fs, and to clock the DAC's 24, a higher frequency synchronous master clock MCLK is needed. Usually tis clock is supplied at 256 fs or 384 ft, although lower rates can be used.

Transfer of audio data in PCM format from a sending chip (for example the digital system processor or decoder 3, or the audio ADC 13 of FIG. 1) to a receiving chip (for example the audio DAC 4, or encoder 14 respectively of FIG. 1) is almost always performed serially. A serial clock, BITCLK, clocks the data between the two chips. In addition, a frame clock LRCLK is used to identify the start and end of each audio word for PCM, and runs at the audio sample rate fs.

In PCM data transfers, data is sent in 16 to 24 bit words, framed by the LRCLK which runs at the audio sample rate. Customarily, both left and right channel digital source data is multiplexed on one data interface channel, with the polarity of LRCLK determining whether data is interpreted as left or right channel data, so 32 to 48 bits of audio data need to be transmitted per audio sample time 1/fs. In theory the BITCLK need only be sufficiently fast to ensure that there are enough BITCLK edges per LRCLK period to clock all the 32 to 48 audio bits into the recipient chip. However, typically a BITCLK of 64 fs or 64x the LRCLK frequency is used, as this is easier to generate. This would allow 64 bits of audio data to be transmitted, i.e. 32-bits in stereo, though in practice the 146 dB of dynamic range offered by stereo 24 bits is more than enough. In theory, BITCLK could be asynchronous to LRCLK as long as it was fast enough, but in practice this would certainly cause noise problems, and is never done.

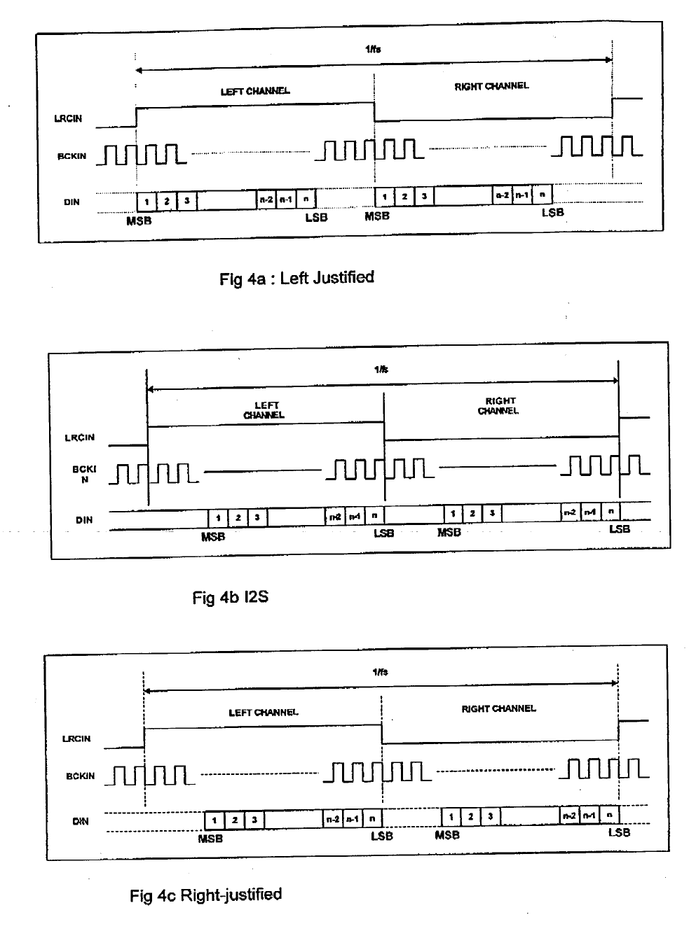

Referring to FIGS. 4a, 4b and 4c, several different orientations of the Audio data packet with respect to the LRCLK frames are customarily used. Left justified is shown in FIG. 4a. Most common is the I2S™ (FIG. 4b) format which places the audio packet one BITCLK after the LRCLK edges, with the word oriented MSB first Another common format is Right Justified (RJ) (FIG. 4c) which places the audio packet MSB first, with the LSB of the word against the LRCLK edge (hence ‘Right Justified’).

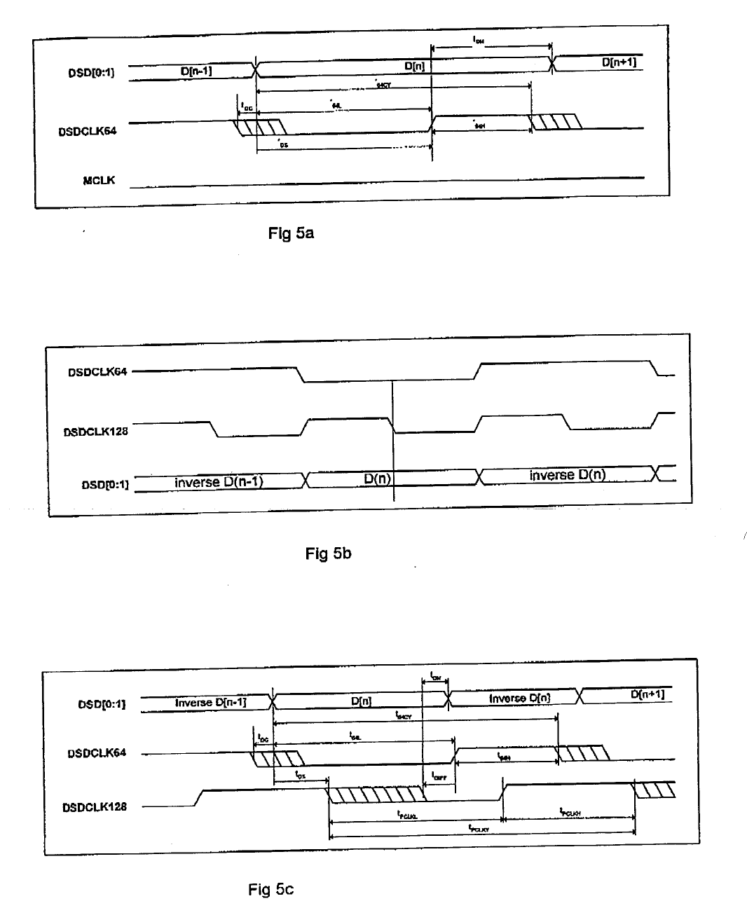

Referring to FIG. 5a, DSD data comprises a bit-stream which is effectively a stream of one bit wide audio samples. In existing art, separate left and right channel data wires DSDLEFT and DSDRIGHT are used for the two data channels. No master clock (MCLK) is generally required as no interpolation is required. Only a clocking signal DSDCLK64 at the same rate as the data is required, to clock the data into the receiving chip and to clock the output DAC 24.

As was noted earlier, the DAC for DSD systems can be as simple as a low pass filter. However a weakness of this method of DSD data transfer is that the audio signal spectrum is present in the digital signal and so it is very likely that the incoming digital signals will corrupt the sensitive analogue signal outputs from the DAC. To avoid this the digital data is often bi-phase coded as shown in FIG. 5b which removes the spectral energy from the audio base-bands. In order to easily recover the bi-phase coded data, a double bit-rate clock (here shown as DSDCLK128) is typically sent along with the data and the existing data-rate clock. Alternatively DSDCLK128 can be a 64 fs clock, in quadrature with DSDCLK64 (FIG. 5c).

In devices that are required to support both PCM and DSD data formats, one of two approaches can be taken as described previously with respect to FIG. 2. Either both interface types are provided (as shown in FIG. 2a), so needing 4 pins for each interface; or the 4 pins for each interface type are recommitted when the interface type is changed (as shown in FIG. 2b).

In the latter case, the 4 pins will typically remap as follows:

| PCM mode | DSD mode |
|---|---|
| MCLK | DSDCLK128 |
| BITCLK | DSDCLK64 |
| LRCLK | DSDLEFT |
| DIN | DSDRIGHT |

This requires that the receiving and sending chips must re-map their input/output interfaces to match each other. For the sending chip this requires an interface similar to FIG. 2b but with opposite signal directions, As already mentioned, a major disadvantage of this arrangement is that on transfer from DSD to PCM mode and vice versa, since data lines become clock lines or vice versa, it is hard to ensure a glitchless transition, for either transmitter or receiver, with all clocks and data switching cleanly at exactly the right time, and no spurious signals being generated by the sender or misinterpreted due to the internal latency of the receiving circuitry.

A further problem arises when this interface is used to support more than 2 data channels. In a 6 channel case (a typical DSD or PCM case nowadays) then the DSD system needs 4 more pins to support the extra 4 data channels. In the PCM case only a further 2 pins are needed, as two audio channels are sent over each wire. Hence 2 more pins are needed in a DSD solution. This discrepancy increases further as the number of data channels increases.

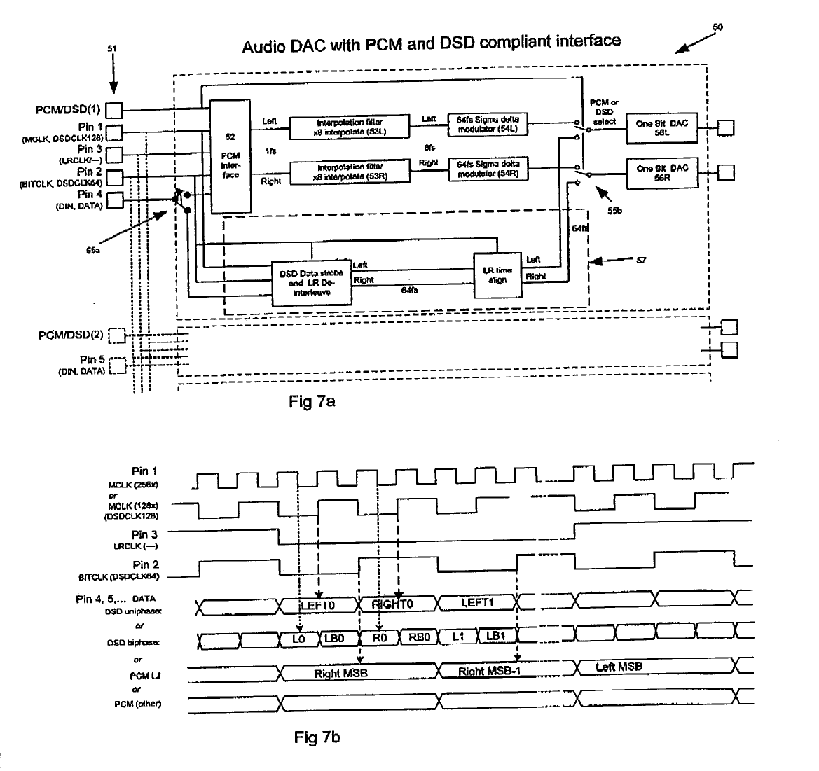

Referring to FIG. 7, a method of and apparatus or transferring PCM and DSD signals according to an embodiment of the present invention is shown. The embodiment provides a communications or signal transfer interface between a decoder (or encoder) chip and audio filter DAC (or ADC) chip of a CD or DVD player (or recorder).

For two source data channels (L+R), four interface channels (in this case conductor paths and input/output pins) are used. An additional interface channel is required for each additional pair of source data channels. This requirement is the same irrespective of whether PCM or DSD source data channels are transferred. This means that a fixed and equal number of input/output pins can be used at each chip (sender and receiver) for a given number of source data channels, irrespective of whether these are encoded as PCM or DSD signals.

The embodiment multiplexes the DSD LEFT and DSD RIGHT source data channels onto a single interface data channel (DATA). This corresponds to the PCM data channel DIN, and these two data signals are assigned to the same interface data channel (DATA), in this case conductor path PIN4 as shown in FIG. 7.

The PCM BITCLK signal and the DSDCLK64 signal are assigned to the same interface clock channel (BITCLK), conductor path PIN2. These two signals are clocking signals for clocking the data bits between the chips, and they are preferably implemented to run at the same rate, preferably 64 fs, irrespective of whether the interface is operating with PCM or DSD signals. By implementing the PCM BITCLK and DSDCLK64 signals at the same rate (64 fs), there is no change in this signal when the data signal type is changed.

This also allows both PCM and DSD signals to run over the interface simultaneously (when there is more than one interface data channel). For example if 5.1 audio is needed to playback in one room, while the same or different audio is played back in stereo in speakers in another room or by wireless headphones, or a stereo signal is needed for an analog or digital (e.g. S/PDEF output) recording output.

Left and right channel DSD data bits are interleaved onto a shared dataline (Pin 4), and this requires a channel framing clock to identify left and right channel data (in the same way as LRCLK is used to identify left and right words in PCM mode, but in this case at the bit rate rather than the word rate.) By using both edges of the framing clock (BITCLK) signal, a 64 fs rate clocking signal can be used. That is the same as the PCM BITCLK rate for this embodiment.

By strobing the DSD data into the receiving chip on any safe MCLK edge available after the framing BITCLK edge, both regular un-coded, and also bi-phase coded data can be accommodated. The PCM MCLK at 256 or 384 fs provides an ideal and convenient clock to perform this data strobing.

The remaining LRCLK channel is used for clocking words in PCM mode, and is unused in DSD mode, and may be left running at fs or disabled.

As a result, MCLK, LRCLK, and BITCLK signals are identical for both PCM and DSD data modes, and only the data lines for each pair of channels are required to change format between PCM and DSD modes. Thus, the switching matrix requirement shown in FIG. 2b is reduced to a single switch (as shown in FIG. 7a) (or equivalent logic gating), just for the DATA interface channel. More importantly, changing from PCM to DSD data is far simpler because lines do not have to be switched between data and clock signals, and thereby eliminating the problems mentioned above which occur in the prior art from doing this. Whilst it is preferred to have the clock lines BITCLK and MCLK run at the same speed for both PCM and DSD modes, it is possible that the clock rates could be different. However the interface channels are still dedicated to either data or clock signals, and thus the glitchness problems associated with prior art arrangements such as shown in FIG. 2b are avoided.

Furthermore the same number of pins are needed for both modes, regardless of the number of source data channels supported.

In addition, bi-phase and normal un-coded DSD data can be supported with no set-up changes. The MCLK frequency can be any rate from 128x fs (for uniphase), or 256× fs (for biphase). PCM and DSD data can also be mixed at the same time—an 8 channel audio filter DAC could support 6 channels of DSD data AND two channels of PCM data at the same time (if LRCLK is kept running).

The arrangement also requires a control signal to indicate whether PCM, DSD or both signal formats are to be transferred. This can be implemented as a dedicated control pin (as shown for simplicity) between each chip or as software based instructions input to the chip(s) via a separate interface stored in an on-chip control register (as preferred).

The interface arrangement may also be applied between an audio filter ADC chip 14 and an encoder chip 13 as shown in FIG. 1b. In either case, either the data sending or receiving chip may be implemented as Master (sending), or Slave (receiving) with respect to clocking signals (BITCLK, MCLK, LRCLK). This is described in more detail below.

Referring again to FIGS. 7a and 7b a receiving chip and interface channel signals are shown. The receiving chip can receive either or both PCM and/or DSD data, so that there need be no changes to any of the clock channels (BITCLK, MCLK, LRCLK) when changing mode from PCM to DSD mode or vice versa The BITCLK at 64 fs is fast enough to allow PCM data of up to 32 bit resolution to be clocked into the PCM part of the interface per LRCLK, and it is the correct fs rate for the DSD interface. In the dual use scenario (ie transfer both PCM and DSP data) the BITCLK(64 fs) is the LR clock for the DSP data, while at the same time being the BITCLK for the PCM data stream.

The LRCLK interface clocking channel is used for L/R clocking of the PCM format data only. MCLK is used by both the PCM and DSD data. This dual mode allows DSD (uniphase) and PCM preferably with an MCLK of 128 fs or multiples thereof and DSD (bi-phase) and PCM with an MCLK of 256 fs or greater in multiples of 128 fs. Typically, a system will already have a 256 fs master clock available, so this is the natural choice.

(Usually, MCLK, LRCLK, and BITCLK edges are aligned, for convenience. But alternatively a 64 fs MCLK delayed by say a quarter-period (i.e. 11256 fs) from the 64 fs BITCLK would adequately sample uniphase DSD data, or a 128 fs MCLK delayed by 1/512 fs could adequately sample bi-phase DSD data, in a similar fashion to that shown in FIG. 5c

The receiving chip, in this case an audio filter DAC chip 50 comprises an input interface 51 comprising four pins corresponding to the four channels of the transfer format or interface, together with an additional control pin for indicating whether the incoming signal is PCM or DSD (or both). The four interface channels/pins are MCLK, LRCLK, BITCLK, DATA. Only the interface data channel DATA signal changes with the signal mode (PCM or DSD).

The chip 50 also comprises PCM and DSD interfaces 52 and 57 respectively, for recovering the data information using the clocking signals sent over the interface (51).

In addition the control signal indicating whether the received data is PCM or DSD format, is used to control two switches 55a and 55b to switch between the PCM and DSD processing circuitry. Note that for switch 55a at the input interface 51, only one line (the DATA channel) requires switching as the clog signals are the same irrespective of data type. The PCM interface 52 recovers left and right PCM words using the clock signals. These are then input into corresponding left and right (8x) Interpolation Filters 53 which interpolates these signals to the higher rate (x8). The outputs from the interpolation filters 53 are input into corresponding Left and Right Sigma Delta Modulators 54, which oversample this data at 64 fs and output the sampled data in the form of a bit stream (at 64 fs). The bit stream for each channel is then feed to a corresponding DAC 56 which outputs analogue signals. Each DAC 56 is typically a single bit switched capacitor type; although other types could alternatively be used for example switched-current or multi-bit DAC structures.

If the DSD interface 57, is selected instead, it recovers left and right DSD data as separate bit streams which arm then feed into the DAC's 56 to generate corresponding analogue signals. The DSD interface 57 is described in more detail below.

Multiple data interface channels of the above circuit could be connected in parallel with shared MCLK and BITCLK, and respective PCM/DSD and DATA inputs. LRCLK can either be shared or be supplied on a per-channel basis For example, 5+1 channels of DSD data could be received at the same time as 2 channels of PCM in an 8-channel system. A multi-channel circuit will generally have a separate serial control bus to program the device configuration, so preferably the PCM/DSD control will be on-chip control signals rather than separate pins.

Note the above circuit has assumed that Left-channel DSD data corresponds to BITCLK low, and DSD data changing on the falling edge of MCLK By merely inverting these signals, the opposite polarity conventions can be accommodated. Alternatively one or more XOR gates with clock and control signals as inputs can be used in a well-known technique to switch the polarities of individual clock lines in a programmable fashion.

Referring to FIGS. 6a and 6b, a PCM interface circuit and timing diagram are shown.

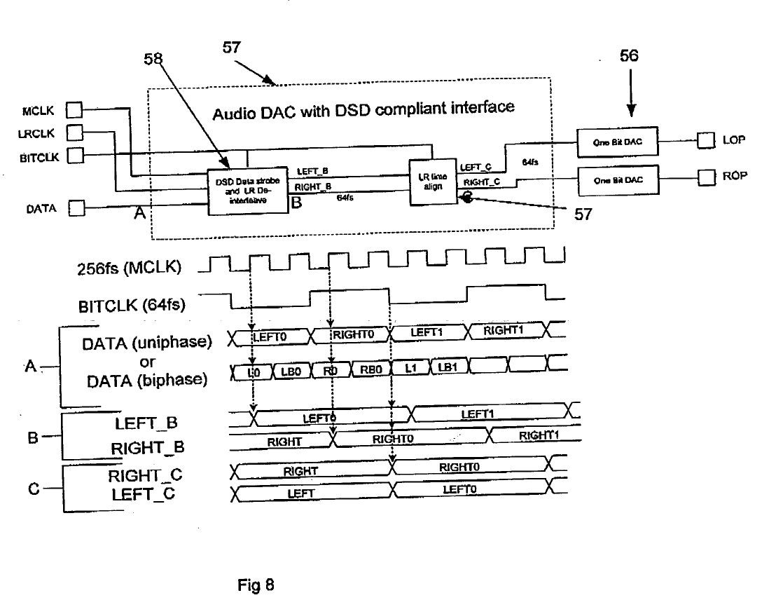

DATA is sampled by BCLK and these samples clocked along a shift register to produce 24 parallel output lines. Meanwhile a pulse is generated on ED at every transition of LRCLK. This clears a counter at LRCLK, which then counts up subsequent BCLK sampling edges. Depending on the polarity of LRCLK, a pulse LATCHL or LATCHR is generated once a count of 22 is reached. This pulse latches in the 24 samples of DATA currently stored in the shift register. LEFT data is also re-latched on LTCHR to align LEFT and RIGHT channel data FIG. 8 shows the DSD interface 57 in more detail, with the relevant timing diagrams at each stage for DSD regeneration. The DSD interface 57 is made up of two components, one is the DSD strobe and de-interleave function 58, and the other is the left/right time align function 59, needed to make sure there is no phase shift in the system.

Receiving the interleaved DSD data synchronized to BITCLK as shown in FIG. 8, the receiving chip has to clock the data into the receiving chip at a suitable point for both bi-phase and uni-phase operation. This requires a strobe signal, in the form of a clock edge, to occur after both the rising and falling edges of the BITCLK (64 fs). This strobing will de-interleave the left and right channels of data, leaving a ½ BITCLK period between the left and right channel samples.

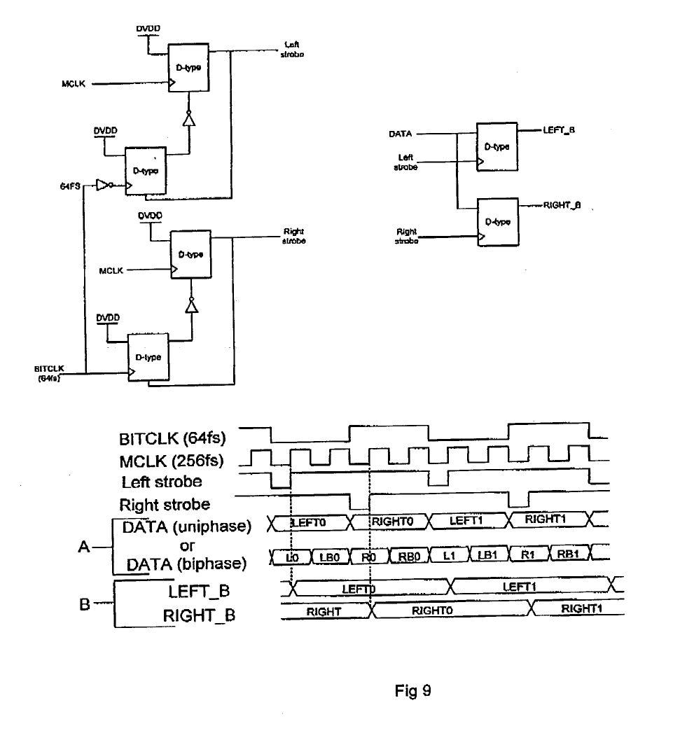

A preferred strobe generation circuit is shown in FIG. 9. The circuit on the left generates strobe pulses for left channel with rising edge on the first rising edge of MCLK after the falling edge of BITCLK, and for the right channel with rising edge on the first MCLK rising edge after the rising edge of BITCLK The circuit on the right then strobes the data on these respective rising edges, i.e. the left channel data will be strobed on the first rising edge of MCLK after the falling edge of BITCLK, and the right channel would be strobed on the first MCLK rising edge after the rising edge of BITCLK As noted above by using a XOR gate on the MCLK the polarity could be changed so that it is the first falling edge of MCLK after a BITCLK edge. This way the circuit can accommodate the different ways some of the clocks might be generated, by the external DSP chip.

For this strobing to happen without glitches there has to be some timing constraints between the BITCLK(64 fs) and MCLK signals. This will not generally be an issue, since MCLK and BITCLK will be generated by the transmitting chip.

For biphase mode MCLK has to be at least 256fs or greater and in uniphase a 128fs or greater clock is required. The circuit will still work with a 384 fs MCLK.

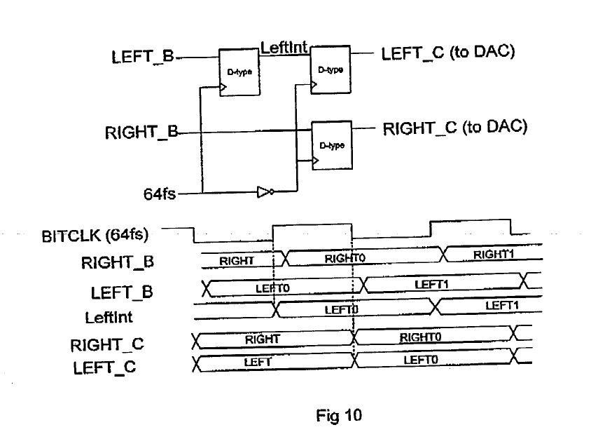

As shown in FIG. 9, the data that comes out of the LR de-interleave block 58 has a 1/2 BITCLK delay on the right channel, also known as a phase shift as the left and right channels aren't aligned. The time delay has to be removed so that the left and right channels are in phase, that is they both change on the same BITCLK edge. For this to happen the left channel is delayed by 1/2 BITCLK by clocking it on the rising edge of BITCLK, so that the left and right channels data can now be retimed onto the falling edge of BITCLK, as shown in FIG. 10.

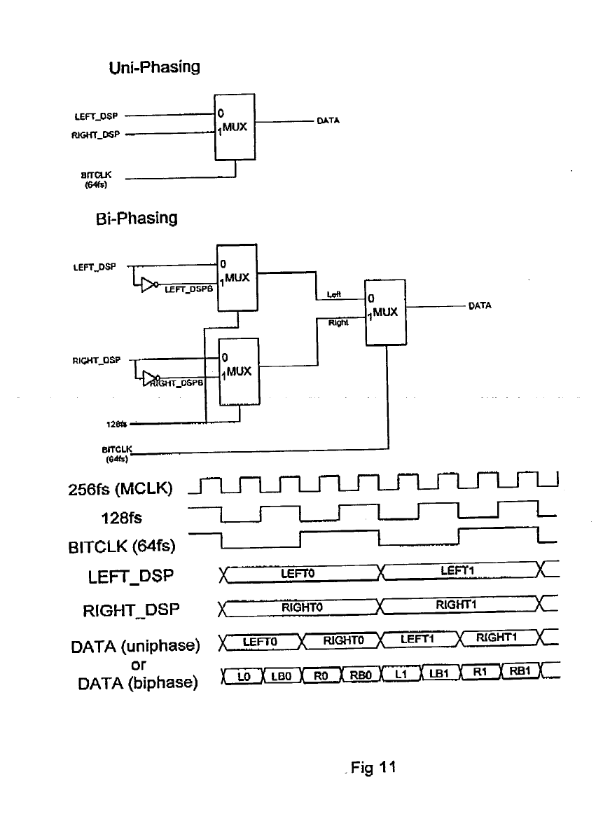

Modifications required for a sending chip arc minor and very little needs to be added to the existing circuitry already used within the sending chip (for example the decoder 3 of FIG. 1a). The prior art DSD systems will generally produce left and right data on separate wires, shown as LEFT_DSP and RIGHT_DSP in FIG. 11, as required for the old, non-interleaved, data format. By interleaving the left and right channels using the multiplexer circuitry shown in FIG. 11, the DSD interleaved bitsteam can be used to create either uniphase data (top circuit) or biphase data (lower circuit). Depending on the exact timing of the clocks and data generated at the sending or transmitting chip output, this simple circuitry may produce glitches in the data, as the data changes at the same time as the multiplexer switches, but these can be removed by using further latches to retime the data, in this case using either a 128fs clock for uniphase data or 256fs clock for biphase data.

The clock signals for the interface channels (BITCLK, MCLK, LRCLC) can be generated and sent by either chip; that is either the data sending or receiving chips. Thus either chip may act as the CLK master (the one generating and sending the clock signals onto the interface channels), or a CLK Slave (receiving clock signals from the Master CLK chip). Thus the clock signals on the MCLK, BITCLK and LRCLK interface channels can flow in either direction—with or against the direction of the data traffic.

For example, for the audio filter DAC, we have assumed that MCLK is generated upstream by e.g. the DVD reader, so the DVD reader would be the Master and the DAC the Slave. It is possible to generate MCLK in the audio filter DAC and send it back to the reader where some circuitry (probably PLL-based) will lock the flow of data to this clock. In this case the DAC is regarded as the Master and the DVD reader the slave.

Similarly for the ADC/writer combination.

The audio filter DAC50 of FIG. 7a could be implemented as the Master for clock signals MCLK, BITCLK and/or LRCLK with minor modifications. The chip 50 would additionally contain a clock generator for the MCLK signal, with dividers to provide the BITCLK and LRCLK signals. These signals would then be sorted to Pins, 1, 2 and 3 to provide both the correct clock signals for the audio filter DAC50, as well as the CLK slave chip on the other end of the interface 51; for example the decoder 3 of FIG. 1a.

Whilst embodiments have been described with respect to transferring PCM and DSD format data between chips in DVD and CD equipment, other applications are contemplated. For example, PCM and/or DSD signals could be transferred directly between audio equipment such as separate CD player and digital power amplifier apparatus. Similarly these signals could be transferred directly between a digital microphone or other source to a DVD recorder.

The present invention has been described with reference to embodiments thereof.

Alterations and modifications obvious to those skilled in the art are intended to be incorporated within the scope hereof.

1. An apparatus for receiving PCM or DSD signals; comprising:
a data receiver arranged to receive multiplexed PCM and DSD format data on a same dedicated interface data channel (DATA);
a first clock signal receiver or transmitter arranged to receive or transmit respectively a first clock signal for both PCM and DSD data reception on a first dedicated interface clock channel (BITCLK);
a second clock signal receiver or transmitter arranged to receive or transmit respectively a second clock signal for both PCM and DSD data reception on a second dedicated interface clock channel (MCLK).

2. An apparatus according to claim 1 further comprising a third clock signal receiver or transmitter arranged to receive or transmit respectively a third clock signal on a third dedicated interface clock charnel (LRCLK).

3. An apparatus according to claim 2 wherein each said interface channel corresponds to a single connection pin on said apparatus.

4. An apparatus according to claim 1 further comprising a second data receiver arranged to receive multiplexed PCM and DSD format data on a second dedicated interface data channel (DATA2).

5. An apparatus according to claim 4 wherein one of said interface data channels (DATA, DATA2) carries PCM format data and the other (DATA2, DATA) carries DSD format data.

6. An apparatus according to claim 1 wherein the rate of the first clock signal is independent of whether PCM or DSD data is received.

7. An apparatus according to claim 1 where the rate of the first clock signal is equal to the bit rate of the multiplexed PCM data or half the bit rate of the multiplexed DSD data.

8. An apparatus according to claim 7 wherein the rate of the first clock signal is 64 fs, where fs is the sampling rate of the PCM channel.

9. An apparatus according to claim 1 wherein the rate of the second clock signal is independent of whether PCM or DSD data is received.

10. An apparatus according to claim 9 wherein said the second clock signal rate is 128 fs, 256 fs, or 384 fs.

11. An apparatus according to claim 2 wherein the rate of the third clock signal is dependent on the sample rate of any PCM data carried on the data channel.

12. An apparatus according to claim 1 wherein the DST data is bi-phase coded DSD format data.

13. An apparatus according to claim 1 further comprising a clock which generates said first (BITCLK) and/or said second (MCLK) and/or said third (LRCLK) clock signals.

14. An apparatus according to claim 1 further comprising a strobe circuit which generates a strobe pulse from the first clock signal (BITCLK) in order to recover the multiplexed DSD source data channel signals from the data interface channel (DATA).

15. An apparatus according to claim 14 further comprising an alignment circuit arranged to time align said recovered DSD source data channel signals.

16. An apparatus according to claim 1 wherein the apparatus is an encoder for a CD or DVD player.

17. An apparatus according to claim 1 wherein the apparatus is an audio DAC chip for a CD or DVD player.

18. An apparatus for transmitting PCM or DSD signals; comprising:
a data transmitter arranged to transmit multiplexed PCM and DSD format data on a same dedicated interface data channel (DATA);
a first clock signal receiver or transmitter arranged to receive or transmit respectively a first clock signal for both PCM and DSD data reception on a first dedicated interface clock channel (BITCLK);
a second clock signal receiver or transmitter arranged to receive or transmit respectively a second clock signal for both PCM and DSD data reception on a second dedicated interface clock channel (MCLK).

19. An apparatus according to claim 18 further comprising a third clock signal receiver or transmitter arranged to receive or transmit respectively a third clock signal on a third dedicated interface clock channel (LRCLK).

20. An apparatus according to claim 19 wherein each said interface channel corresponds to a single connection pin on said apparatus.

21. An apparatus according to 18 further comprising a second data transmitter arranged to transmit multiplexed PCM and DSD format data on a second dedicated interface data channel (DATA2).

22. An apparatus according to claim 21 wherein one of said interface data channels (DATA, DATA2) carries PCM format data and the other (DATA2, DATA) carries DSD format data.

23. An apparatus according to claim 18 wherein the rate of the first clock signal is independent of whether PCM or DSD data is received.

24. An apparatus according to claim 18 wherein the rate of the second clock signal is independent of whether PCM or DSD data is received.

25. An apparatus according to claim 18 further comprising a clock which generates said first (BITCLK) and/or said second (MCLK) and/or said third (LRCLK) clock signals.

26. An apparatus according to any one of claim 18 wherein the apparatus is a decoder for a CD or DVD player.

27. An apparatus according to claim 18 wherein the apparatus is an audio ADC chip for a CD or DVD recorder.

28. A method for receiving PCM or DSD signals; comprising:
receiving multiplexed PCM or DSD format data on a same dedicated interface data channel (DATA);
receiving or transmitting a first clock signal for both PCM and DSD data reception on a first dedicated interface clock channel (BITCLK);
receiving or transmitting a second clock signal for both PCM and DSD data reception on a second dedicated interface clock channel (MCLK).

29. A method according to claim 28 further comprising receiving or transmitting a third clock signal on a third dedicated interface clock channel (LRCLK).

30. A method according to claim 28 further comprising receiving multiplexed PCM or DSD format data on a second dedicated interface data channel (DATA2).

31. A method according to claim 30 wherein one of said interface data channels (DATA, DATA2) carries PCM format data and the other (DATA2, DATA) carries DSD format data.

32. A method according to claim 28 wherein the rate of the first clock signal is independent of whether PCM or DSD data is received.

33. A method according to claim 28 wherein the rate of the second clock signal is independent of whether PCM or DSD data is received.

34. A method according to claim 28 further comprising generating a strobe pulse from the first clock signal (BITCLK) in order to recover the multiplexed DSD source data channel signals from the data interface channel (DATA).

35. A method according to claim 34 flier comprising time aligning said recovered DSD source data channel signals.

36. A method for transmitting PCM or DSD signals; comprising:
transmitting multiplexed PCM or DSD format data on a same dedicated interface data channel (DATA);
receiving or transmitting a first clock signal for both PCM and DSD data reception on a first dedicated interface clock channel (BITCLK);
receiving or transmitting a second clock signal for both PCM and DSD data reception on a second dedicated interface clock channel (MCLK).

37. A method according to claim 36 further comprising receiving or transmitting a third clock signal on a third dedicated interface clock channel (LRCLK).

38. A method according to claim 36 further comprising transmitting multiplexed PCM or DSD format data on a second dedicated interface data channel (DATA2).

39. A method according to claim 38 wherein one of said interface data channels (DATA, DATA2) carries PCM format data and the other (DATA2, DATA) carries DSD format data.

40. A method according to claim 36 wherein the rate of the first clock signal is independent of whether PCM or DSD data is received.

41. A method according to claim 36 wherein the rate of the second clock signal is independent of whether PCM or DSD data is received.

42. An interface signal for transmitting or receiving DSD signals; comprising:
a data interface signal (DATA) carrying multiplexed DSD format data;
a first clock signal (BITCLK) having a rate equal to the bit rate of the unmultiplexed DSD format data;
a second clock signal (MCLK) having a rate higher than the first clock signal.
